(19) United States
(12) Patent Application Publication
(10) Pub. No.: US 2024/0079590 A1
(43) Pub. Date: Mar. 7, 2024

(54) NOVEL GRAPHITE PASSIVATION METHOD

(71) Applicant: PHILLIPS 66 COMPANY, HOUSTON, TX (US)

(72) Inventors: Neal D. McDaniel, Bartlesville, OK (US); Anthony O. Baldridge, Bartlesville, OK (US); Moncy Yang, Owasso, OK (US); Jon M. Nelson, Claremore, OK (US); Samuel J. Baxter, Bartlesville, OK (US); Jianhua Yao, Bartlesville, OK (US)

(73) Assignee: PHILLIPS 66 COMPANY, HOUSTON, TX (US)

(21) Appl. No.: 18/458,769

(22) Filed: Aug. 30, 2023

Related U.S. Application Data
(60) Provisional application No. 63/403,491, filed on Sep. 2, 2022.

(51) Int. Cl. H01M 4/583; H01M 4/04

(52) U.S. Cl. CPC H01M 4/583; H01M 4/0471; H01M 2004/027

(57) ABSTRACT

A method of making an anode material. The method begins by mixing a pre-passivated anode graphite with a supplement and a solvent to create a mixture. The solvent is then evaporated from the mixture to create a passivated anode graphite particle.

### CROSS-REFERENCE TO RELATED APPLICATION

This application is a non-provisional application which claims the benefit of and priority to U.S. Provisional Application Ser. No. 63/403,491 filed Sep. 2, 2022, entitled “Novel Graphite Passivation Method,” which is hereby incorporated by reference in its entirety.

### STATEMENT REGARDING FEDERALLY SPONSORED RESEARCH OR DEVELOPMENT

None.

### FIELD OF THE INVENTION

This invention relates to a novel graphite passivation method.

### BACKGROUND OF THE INVENTION

Modern batteries work by shuttling lithium ions back and forth between two hosts, one at the cathode and one at the anode. Lithium ions are conducted between the electrodes through an electrolyte mixture consisting of a lithium salt in a combination of organic carbonates, empirically optimized to give high lithium ion availability (capacity) and mobility (power). Many of the components used in these electrolytes are not electrochemically stable at the low potentials reached by the anode when the battery charges. When graphite is used as an anode material in lithium-ion batteries, its surface must be protected from interactions with the battery solvent, as the solvent will decompose on the graphite during charging of the battery, leading to poor battery performance. At the same time, any protective/passivating coatings used on graphite's surface must remain permeable to lithium ions, so that the anode can charge normally.

Before a lithium-ion battery anode can be used the surface of graphite particles must be passivated to prevent decomposition of battery electrolyte during service. Passivation is the main “observable” effect of a surface reaction that occurs spontaneously onto lithium metal surfaces in all primary lithium batteries based on a liquid cathode. The corrosion of lithium metal into lithium ions leads to the formation of a solid protecting layer, the “passivation layer”. This layer helps in preventing further corrosion and more importantly, avoiding any internal short-circuits of the battery. It acts in a similar way to paint protecting against metal corrosion; it protects the cells from discharging on their own and enables their long shelf life. First cycle efficiency is the direct measure of how well-passivated the surface is.

Others have tried methods to achieve passivation such as pitch-coating, in situ electrolyte additive, and oxide or other ceramic coatings. However, such methods are unable to achieve high levels of first cycle efficiency. There exists a need to passivate graphite with high first cycle efficiencies.

### BRIEF SUMMARY OF THE DISCLOSURE

A method of making an anode material. The method begins by mixing a pre-passivated anode graphite with a supplement and a solvent to create a mixture. The solvent is then evaporated from the mixture to create a passivated anode graphite particle.

A method of making an anode material for lithium ion-batteries consisting essentially of mixing a pre-passivated anode graphite with a solid or liquid supplement and a solvent to create a mixture. The mixture can then be heated to a temperature less than 150° C. to evaporate the solvent to create a passivated anode graphite wherein the supplement coats the passivated anode graphite. The passivated anode graphite is then milled so that the supplement has a thickness between 20 μm to 40 μm to create a passivated anode graphite particle. The first cycle efficiency of the passivated anode graphite particle is greater than 75% and the supplement is less than 5 wt % by mass of the pre-passivated anode graphite.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts passivation of graphite with different sulfonyl chloride species.

FIG. 2 depicts the electrode performance of Example 1.

FIG. 3 depicts the electrode performance of Example 3.

FIG. 4 depicts the electrode performance of Example 4.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present embodiment describes a method of making an anode material. The method can begin by mixing a pre-passivated anode graphite with a supplement and a solvent to create a mixture. The solvent can then be evaporated from the mixture to create a passivated anode graphite particle.

In one embodiment, the anode material can be for a variety of lithium ion batteries known in the art such as lithium iron phosphate, lithium cobalt oxide, lithium manganese oxide, lithium nickel manganese cobalt oxide, lithium nickel cobalt aluminum oxide, or lithium titanate batteries.

In one embodiment, the solvent can be an anti-solvent, or even a solvent/anti-solvent mixture. For example, the solvent can be deposited on the graphite through precipitation by an anti-solvent. Examples of solvents and/or antisolvents can be: linear or branched alkanes, ethers, alcohols, acids, esters, and other organic solvents.

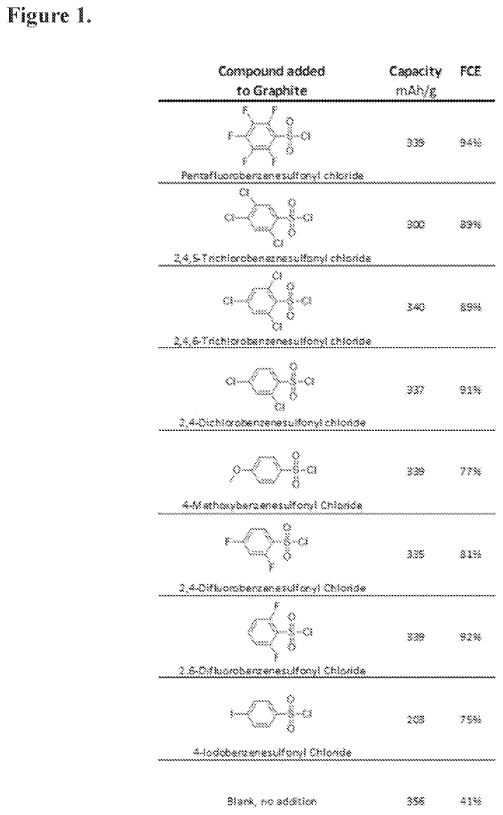

In one embodiment of the method the supplement can be a solid or a liquid. In another embodiment, the supplement does not contain any fluorocarbons. For example, in one embodiment, the supplement is a benzenesulfonyl chloride with at least one substituted electron withdrawing group. Examples of substituted electron withdrawing groups can be selected from the group comprising: a fluorine, a chlorine, a bromine, an iodine, an astatine, a nitrogen, a fused aromatic ring, an unfused aromatic ring, a cyano group, a carbonyl group, and combinations thereof. Further embodiments of the supplement can be selected from the group consisting of: 2-naphthalenesulfonyl chloride, pentafluorophenylsulfonyl chloride, SiO₂ nanospheres, and combinations thereof. It is even possible that in one embodiment, the supplement has a molecular weight less than 1000 atomic mass units. Examples of passivation's of graphite with different sulfonyl chloride species are shown in FIG. 1.

In yet another embodiment, milling can be done prior to forming the passivated anode graphite particle and after the evaporation of the solvent. In one embodiment, the milling can be used to create a particle size distribution centered around 5 μm to 40 μm of the supplement on the passivated anode graphite particle, or in alternate embodiments 20 μm to 40 μm. In other examples the milling can be used to create a thickness from 25 μm to 35 μm. Examples of types of milling that can be used include shearing/shredding, attrition-based milling, compression/crushing, and impact milling.

In one embodiment, first cycle efficiency of the passivated anode graphite particle is greater than 50% in diethyl carbonate or ethyl methyl carbonate dominant electrolytes. In other embodiments, the first cycle efficiency of the passivated anode graphite particle can be greater than 55%, 60%, 65%, 70%, 75%, even 80%, in diethyl carbonate or ethyl methyl carbonate dominant electrolytes.

In yet another embodiment, the supplement is less than 5 wt % by mass of the pre-passivated anode graphite. In other embodiments, the supplement is less than 3 wt % by mass of the pre-passivated anode graphite.

A method of making an anode material for lithium ion-batteries consisting essentially of mixing a pre-passivated anode graphite with a solid or liquid supplement and a solvent to create a mixture. The mixture can then be heated to a temperature less than 150° C. to evaporate the solvent to create a passivated anode graphite wherein the supplement coats the passivated anode graphite. The passivated anode graphite is then milled so that the supplement has a thickness between 20 μm to 40 μm to create a passivated anode graphite particle. The first cycle efficiency of the passivated anode graphite particle is greater than 75% and the supplement is less than 5 wt % by mass of the pre-passivated anode graphite.

The following examples of certain embodiments of the invention are given. Each example is provided by way of explanation of the invention, one of many embodiments of the invention, and the following examples should not be read to limit, or define, the scope of the invention.

### Example 1

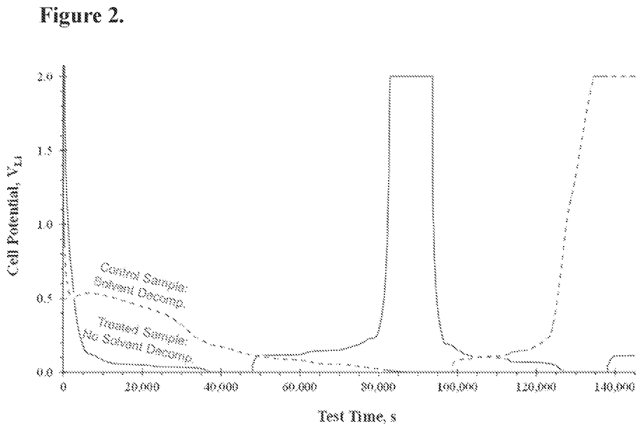

In this embodiment, the contacting of the graphite powder and the supplement is done prior to electrode fabrication. In this example, 0.95 g of graphite powder with a particle size distribution of 5±1 μm was added to a 5 mL toluene solution containing 200 mg pentafluorophenylsulfonyl chloride. This mixture was heated to 85° C. for 2 hrs. The liquid was then decanted to remove the majority of unreacted pentafluorophenylsulfonyl chloride, and the wet powder was dried under vacuum at 80° C. This powder was then used without further modification to fabricate an anode foil for lithium-ion battery testing as follows: 0.95 g graphite was combined with 0.025 g PVDF powder and 0.025 g carbon black. To this mixture was added 2.5 g NMP. This slurry was homogenized by shaking with ⅛″ ball bearings added, in a paint shaker for 10 minutes. The slurry was then cast onto a carbon-coated copper foil, dried under vacuum at 80° C., and calendared to a thickness of 30 μm. 15 mm punches were made, each containing ˜5 mg/cm2 loading, and CR2032 half-cells were assembled from those punches. The resulting performance is shown in FIG. 2.

### Example 2

In this embodiment, the contacting of the graphite powder and the supplement is done after to electrode fabrication. In this example, 0.95 g of graphite powder with a particle size distribution of 5±1 μm was combined with 0.025 g PVDF powder and 0.025 g carbon black. To this mixture was added 2.5 g NMP and 200 mg pentafluorophenylsulfonyl chloride. This slurry was homogenized by shaking with ⅛″ ball bearings added, in a paint shaker for 10 minutes. The slurry was then cast onto a carbon-coated copper foil, dried under vacuum at 80° C., and calendared to a thickness of 30 μm. 15 mm punches were made, each containing −5 mg/cm2 loading, and CR2032 half-cells were assembled from those punches. The resulting performance was in this case lower: 266 mAh/g and 74.6% first cycle efficiency.

### Example 3

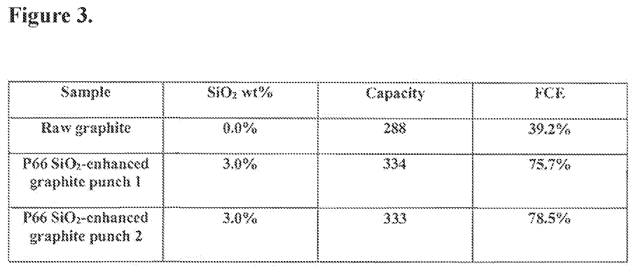

In this example 0.97 g of the above graphite and 0.075 g of Ludox HS-40 (0.03 g SiO₂ nanospheres) were added to 3 mL of H20. The total mixture was emulsified using a vortex spinner for 1 minute and then placed into a glass beaker where it was heated and stirred (90° C.) until full solvent evaporation. The final solid was lightly ground (to break apart clumps) before characterization and battery cycling experiments. This graphite was used without further modification to fabricate an anode foil for cycling experiments in a lithium-ion battery as follows: 0.65 g of silica passivated graphite was combined with 1.21 g of 3% PVDF solution (NMP balance) and 0.01817 g of carbon black. The resulting slurry was homogenized by shaking using five ⅛″ ball bearings for 10 minutes. The final slurry was cast onto a carbon-coated copper foil before subsequent drying under vacuum at 80° C. and calendaring to a thickness of 30 m. This film was punched into 15 mm diameter discs and assembled into a CR2032 half cell with lithium metal as the opposing electrode. No SEI-forming additives were employed. Formation took place at a rate of C/10 (assuming 372 mAh/g), and was followed by a 3 hr, OV CV segment to measure the inherent capacity of the materials. The resulting performance is shown in FIG. 3.

### Example 4

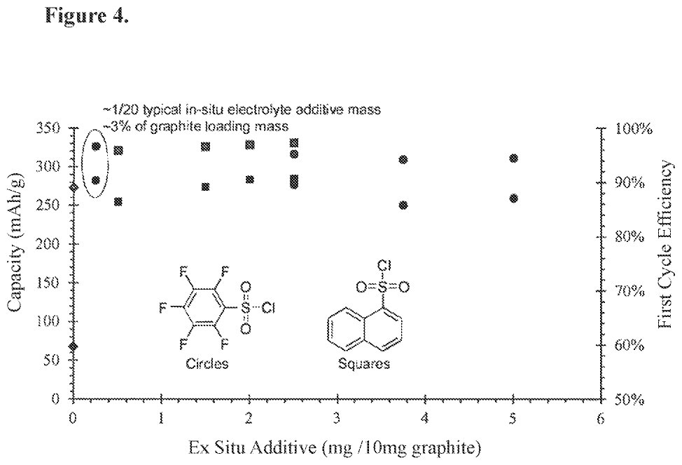

In this example, a graphite electrode was prepared on carbon-coated copper foil at a graphite loading of 6.1 mg/cm2. The electrode solids formulation was 92.5% graphite (synthetic, unshaped/uncoated, particle size distribution D_{SO} of 5±1 μm). 2.5 wt % P50 carbon black, 2 wt % sodium carboxymethylcellulose, and 3 wt % styrene butadiene rubber. Several 15 mm circular punches were made from this uniform electrode, in preparation for CR2032 cell fabrication. Each punch was then treated with a toluene solution containing either pentafluorobenzenesulfonyl chloride (as a previously explored treatment that is known to passivate the graphite) or 2-naphthalenesulfonyl chloride. The concentrations of the treatment solution were varied over a wide range, in order to deliver anywhere from 2.5 wt % to 50 wt % of the sulfonyl chloride species, relative to the mass of graphite present on each circular punch. The impregnated punches were thereafter dried under vacuum at 200° F. for 2 hours to remove residual toluene. Finally, the punches were used in the fabrication of CR2032 half cells by standard methods, in order to afford the first cycle capacity and efficiency data shown in FIG. 4.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of making an anode material comprising:
a. mixing a pre-passivated anode graphite with a supplement and a solvent to create a mixture and
b. evaporating the solvent to create a passivated anode graphite particle.

2. The method of claim 1, wherein the supplement is a solid.

3. The method of claim 1, wherein the supplement is a liquid.

4. The method of claim 1, wherein the supplement does not contain fluorocarbons.

5. The method of claim 1, wherein the supplement is a benzenesulfonyl chloride with at least one substituted electron withdrawing group.

6. The method of claim 5, wherein the substituted electron withdrawing group is selected from a fluorine, a chlorine, a bromine, an iodine, an astatine, a nitrogen, a fused aromatic ring, an unfused aromatic ring, a cyano group, a carbonyl group, and combinations thereof.

7. The method of claim 1, wherein the supplement is selected from the group consisting of: 2-naphthalenesulfonyl chloride, pentafluorophenylsulfonyl chloride, SiO₂ nanospheres, and combinations thereof.

8. The method of claim 1, wherein the supplement has a molecular weight less than 1000 atomic mass units.

9. The method of claim 1, wherein milling is done prior to forming the passivated anode graphite particle.

10. The method of claim 9, wherein the milling creates a particle size distribution centered around 5 μm to 40 μm of the supplement.

11. The method of claim 1, wherein the first cycle efficiency of the passivated anode graphite particle is greater than 75% in diethyl carbonate or ethyl methyl carbonate dominant electrolytes.

12. The method of claim 1, wherein the supplement is less than 5 wt % by mass of the pre-passivated anode graphite.

13. The method of claim 1, wherein the supplement is less than 3 wt % by mass of the pre-passivated anode graphite.

14. The method of claim 1, wherein the solvent is deposited on the graphite through precipitation by an anti-solvent.

15. A method of making an anode material for lithium ion-batteries consisting essentially of:
a. mixing a pre-passivated anode graphite with a solid or liquid supplement and a solvent to create a mixture;
b. heating the mixture to a temperature less than 150° C. to evaporate the solvent to create a passivated anode graphite wherein the supplement coats the passivated anode graphite; and
c. milling the passivated anode graphite so that the supplement has a particle size distribution centered around 5 μm to 40 μm to create a passivated anode graphite particle, wherein the first cycle efficiency of the passivated anode graphite particle is greater than 75% in diethyl carbonate or ethyl methyl carbonate dominant electrolytes and wherein the supplement is less than 5 wt % by mass of the pre-passivated anode graphite.
